(19) United States
(12) Patent Application Publication
(10) Pub. No.: US 2016/0149470 A1
(43) Pub. Date: May 26, 2016

(54) APPARATUS, SYSTEMS, AND METHODS FOR COOLING ROTATING COUPLINGS AND DRIVES

(71) Applicant: MagnaDrive Corporation, Woodinville, WA (US)

(72) Inventors: Dan Durland, Seattle, WA (US); Jeongkwan Lee, Bellevue, WA (US); Lincoln Si, Bellevue, WA (US); Michael Lundquist, Snohomish, WA (US); Rian Rustvold, Kenmore, WA (US); Mike Tomczak, Stanwood, WA (US)

(21) Appl. No.: 14/949,670

(22) Filed: Nov. 23, 2015

Related U.S. Application Data
(60) Provisional application No. 62/084,911, filed on Nov. 26, 2014.

(51) Int. Cl. H02K 9/04; H02K 49/00

(52) U.S. Cl. CPC H02K 9/04; H02K 49/00

(57) ABSTRACT

An embodiment of a cooling apparatus for a magnetic drive or coupling is disclosed. The cooling apparatus may include a housing enclosing the magnetic drive or coupling. The housing may include a cooling air inlet, a cooling air outlet, a drive shaft aperture, and a load shaft aperture. The cooling apparatus may also include an air mover. The air mover may include a cooling air inlet and a cooling air outlet, the cooling air outlet of the air mover may be in fluid communication with the cooling air inlet of the housing.

### BACKGROUND

1. Technical Field The present disclosure relates to apparatuses, systems, and methods for cooling rotating couplings and drives and, more particularly, to enclosures and convection cooling of adjustable speed magnetic drive systems, fixed gap magnetic couplings, and magnetic couplings and drives that include speed trimming, torque limiting, and delayed start features.

2. Description of the Related Art

Magnetic drive systems, which may include fixed gap magnetic couplings or adjustable speed drive systems, operate by transmitting torque from a motor to a load across an air gap. There is no mechanical connection between the driving and driven sides of the equipment. Torque is created by the interaction of powerful rare-earth magnets on one side of the drive with induced magnetic fields on the other side. By varying the air gap spacing, as in adjustable speed drive systems, the amount of torque transmitted can be controlled, thus permitting speed control.

Magnetic drive systems typically include a magnetic rotor assembly and a conductor rotor assembly. The magnetic rotor assembly, containing rare-earth magnets, is attached to the load. The conductor rotor assembly is attached to the motor. The conductor rotor assembly includes a rotor made of a conductive material, such as aluminum, copper, or brass. In some magnetic drive systems, such as the adjustable speed drive systems, the magnetic drive system also includes actuation components, which control the air gap spacing between the magnet rotors and the conductor rotors.

Relative rotation of the conductor and magnet rotor assemblies induces a powerful magnetic coupling across the air gap. Varying the air gap spacing between the magnet rotors and the conductor rotors can control the output speed.

The principle of magnetic induction requires relative motion between the magnets and the conductors. This means that the output speed is always less than the input speed. The difference in speed is known as slip. Typically, slip during operation at a full rating motor speed is between 1% and 3% and in some cases, 5% or more.

The relative motion of the magnets in relation to the conductor rotor causes eddy currents to be induced in the conductor material. The eddy currents in turn create their own magnetic fields. It is the interaction of the permanent magnet fields with the induced eddy current magnetic fields that allows torque to be transferred from the magnet rotor to the conductor rotor. The electrical eddy currents in the conductor material create electrical heating in the conductor material.

The generation of heat in magnetic drive systems, used in a wide variety of environments, in combination with equipment generating high amounts of energy, can limit the power that a drive or coupling can transfer between the magnet rotor and conductor rotor.

### BRIEF SUMMARY

An embodiment of a cooling apparatus for a magnetic drive or coupling is disclosed. The cooling apparatus may include a housing enclosing the magnetic drive or coupling. The housing may include a cooling air inlet, a cooling air outlet, a drive shaft aperture, and a load shaft aperture. The cooling apparatus may also include an air mover. The air mover may include a cooling air inlet and a cooling air outlet, the cooling air outlet of the air mover may be in fluid communication with the cooling air inlet of the housing.

Another embodiment of a cooling apparatus for a magnetic drive or coupling is disclosed. The cooling apparatus may include a lower housing enclosing a magnetic drive or coupling. The lower housing may include a drive shaft aperture, a load shaft aperture, and a top surface including a cooling air inlet and a cooling air outlet. The cooling apparatus for a magnetic drive or coupling may also include an air mover housing coupled to the top surface of the lower housing. The air mover housing may include an air mover compartment and an air outlet compartment. The air mover compartment may enclose an air mover and have an air inlet aperture and motor cutout. The air mover may include a cooling air inlet and a cooling air outlet. The cooling air outlet of the air mover may be in fluid communication with the cooling air inlet of the housing. The air outlet compartment may couple the external environment in fluid communication with an interior of the lower housing. The air outlet compartment may include guide veins to direct cooling air between the interior of the lower housing and the external environment.

A method of cooling a magnetic drive or coupling is disclosed. The method may include measuring a temperature of a magnetic drive or coupling, comparing the temperature to a temperature threshold, activating an air mover if the measured temperature is greater than the temperature threshold, bringing air from an external environment and into an enclosure that encloses the a magnetic drive or coupling, removing heat from the magnetic drive or coupling, and exhausting the air back out to the external environment.

### BRIEF DESCRIPTION OF THE SEVERAL VIEWS OF THE DRAWINGS

FIG. 1 is an perspective view illustrating a lower cooling enclosure, according to one or more embodiments disclosed herein.

FIG. 2A is a perspective view of a temperature monitoring system on an adjustable speed magnetic drive, according to one or more embodiments disclosed herein.

FIG. 2B is a perspective view of a conductor rotor, according to one or more embodiments disclosed herein.

FIG. 3 is a perspective view illustrating a cooling system, according to one or more embodiments disclosed herein.

FIG. 4 is a perspective view illustrating a cooling system, according to one or more embodiments disclosed herein.

FIG. 5 is a perspective view illustrating an upper cooling enclosure, according to one or more embodiments disclosed herein.

FIG. 6 is a perspective view illustrating a cooling system, according to one or more embodiments disclosed herein.

FIG. 7 is a perspective view illustrating a cooling system, according to one or more embodiments disclosed herein.

FIG. 8 is a perspective cross-sectional view illustrating a cooling system, according to one or more embodiments disclosed herein.

FIG. 9 is a perspective cross-sectional view illustrating a cooling system, according to one or more embodiments disclosed herein.

FIG. 10 is a perspective cross-sectional view illustrating a cooling system, according to one or more embodiments disclosed herein.

### DETAILED DESCRIPTION

The following detailed description is directed toward apparatuses, systems, and methods for use in connection with cooling magnetic drive systems. The description and corresponding figures are intended to provide an individual of ordinary skill in the art with enough information to enable that individual to make and use embodiments of the invention. Such an individual, however, having read this entire detailed description and reviewed the figures, will appreciate that modifications can be made to the illustrated and described embodiments, and/or elements removed therefrom, without deviating from the spirit of the invention. It is intended that all such modifications and deviations fall within the scope of the invention, to the extent they are within the scope of the associated claims.

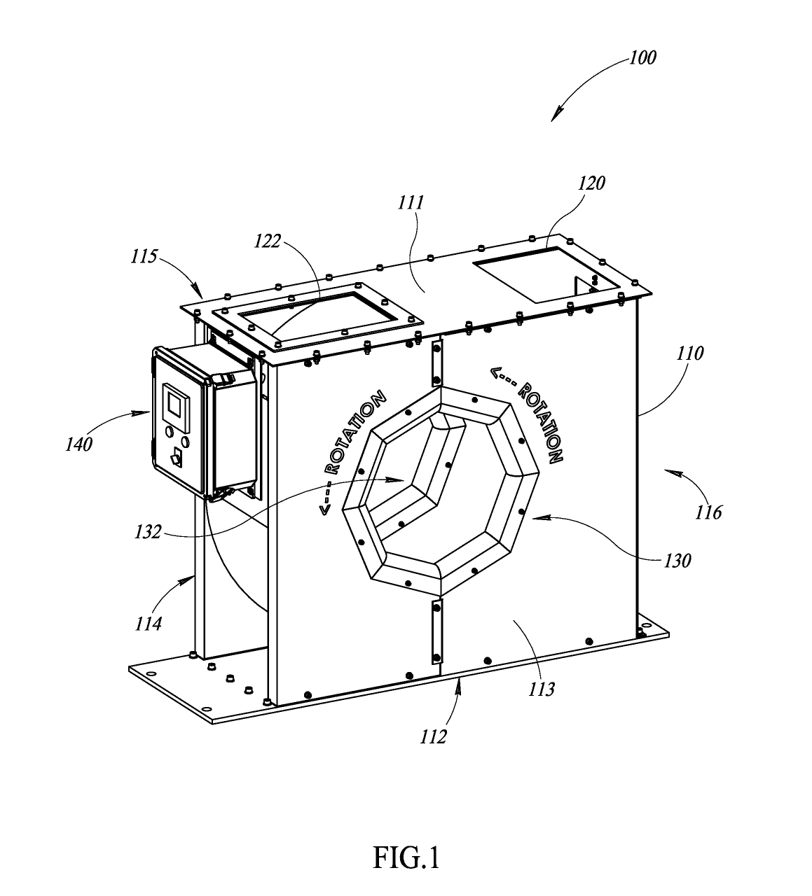

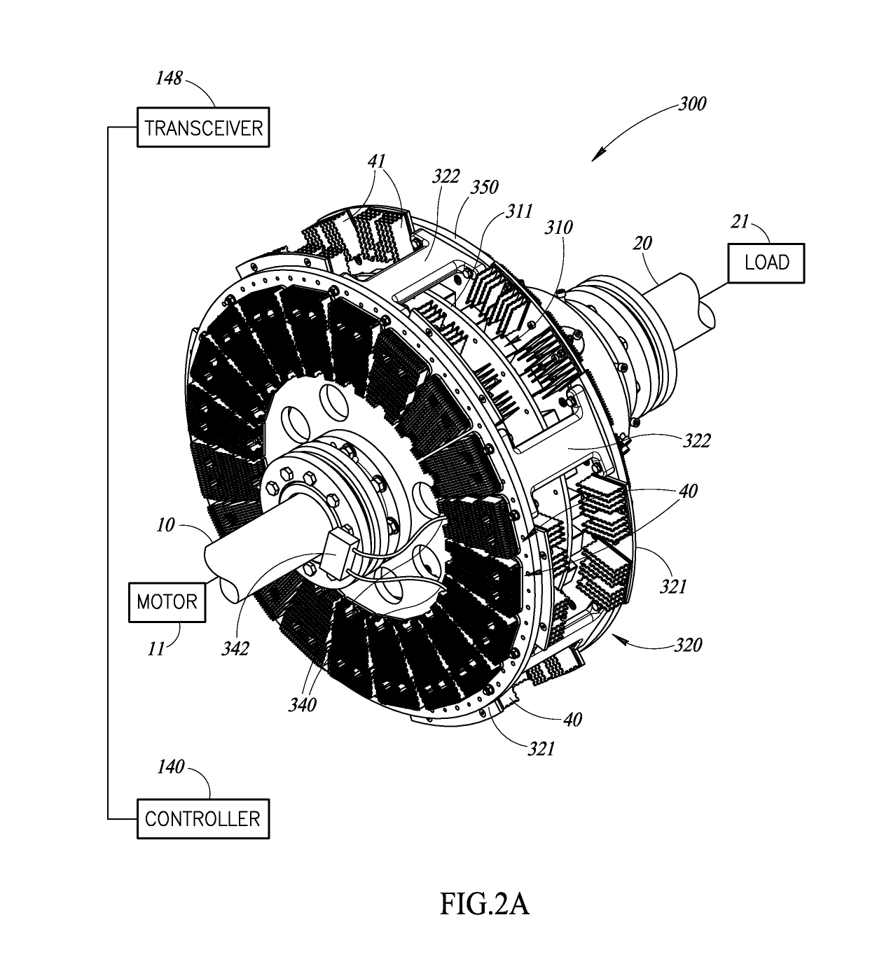

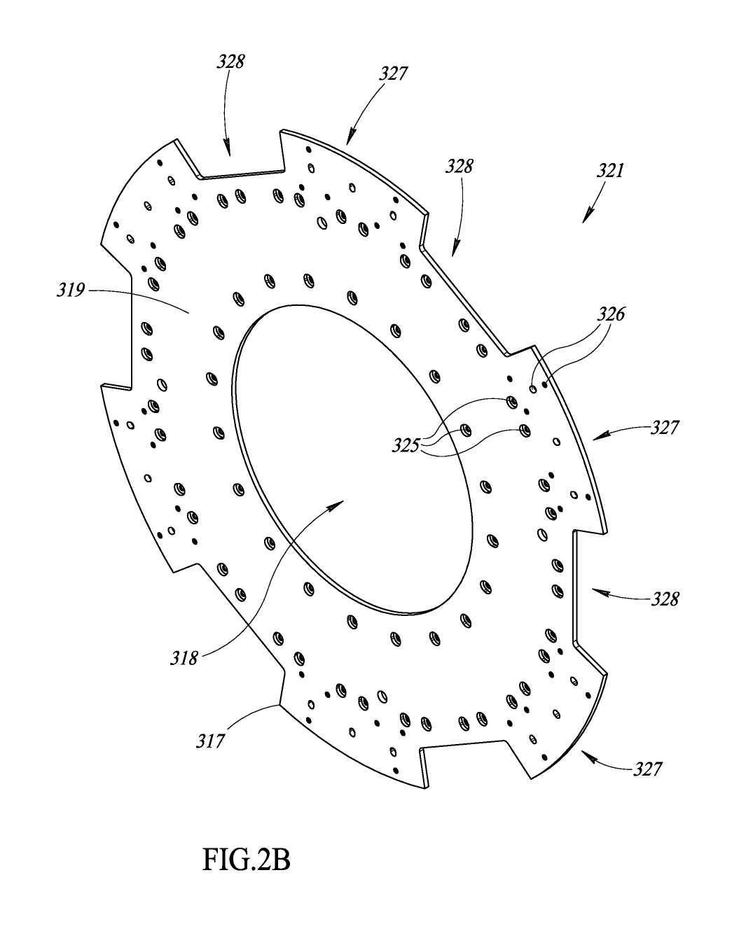

FIG. 1 shows an enclosure 100 for enclosing a magnetic drive system, for example magnetic drive system 300, shown in FIG. 2A. The enclosure includes a lower housing 110. As shown in FIG. 1, in some embodiments, the enclosure may include panels or walls 111, 112, 113, 114, 115, 116. The panels or walls may be a top 111, a bottom 112, and four sides 113, 114, 115, 116. Note that the side 114 is omitted from FIG. 1. In some embodiments, one or more of the top 111, the bottom 112, and the sides 113, 114, 115, 116 may be omitted. For example, in an embodiment wherein the lower housing 110 is placed on or affixed to a floor, a bottom 112 may be omitted. Similarly, other structures other than panels or walls may form or replace one or more of the top 111, the bottom 112, and the sides 113, 114, 115, 116 of the lower housing 110.

In some embodiments, the top 111, the bottom 112, and the sides 113, 114, 115, 116 may include sound attenuating material. For example, foam or other sound attenuating material may be included between the inner and outer weldments, frames or panels.

The enclosure 100 may also include a cooling air inlet 122. In some embodiments, the cooling air inlet 122 may be an aperture formed through the top 111 of the lower housing 110. In some embodiments, the cooling air inlet 122 may be formed through another part of the lower housing 110, for example, the side 116. In still other embodiments, one or more of the top 111, the bottom 112, and the sides 113, 114, 115, 116 of the lower housing 110 may be omitted or otherwise replaced with the cooling air inlet 122. For example, the top 111 may be omitted. In such an embodiment, the cooling air inlet may be bounded by the upper ends of the sides 113, 114, 115, 116.

Although depicted as having a single cooling air inlet 122, in some embodiments, the enclosure 100 may include more than one cooling air inlet 122.

The enclosure 100 may also include a cooling air outlet 120. In some embodiments, the cooling air outlet 120 may be an aperture formed through the top 111 of the lower housing 110. In some embodiments, the cooling air outlet 120 may be formed through another part of the lower housing 110, for example, the side 116. In still other embodiments, one or more of the top 111, the bottom 112, and the sides 113, 114, 115, 116 of the lower housing 110 may be omitted or otherwise replaced with the cooling air outlet 120. For example, the top 111 may be omitted and an air mover outlet may be placed on top of the lower housing 110. In such an embodiment, the cooling air outlet may be bounded by the upper ends of the sides 113, 114, 115, 116. An individual or ordinarily skill in the art, having reviewed this disclosure, will appreciate that the structure, shape, location, and other features of the cooling air inlet 122 and cooling air outlet 120 can be changed without deviating from the spirit of the invention.

Although depicted as having a single cooling air outlet 120, in some embodiments, the enclosure 100 may include more than one cooling air outlet 120.

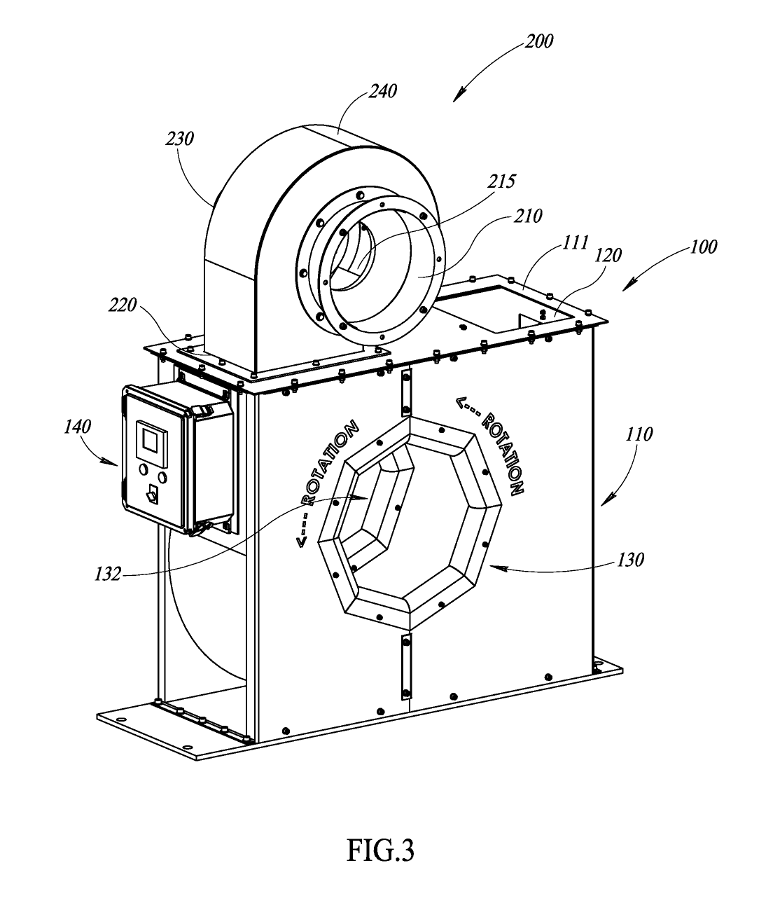

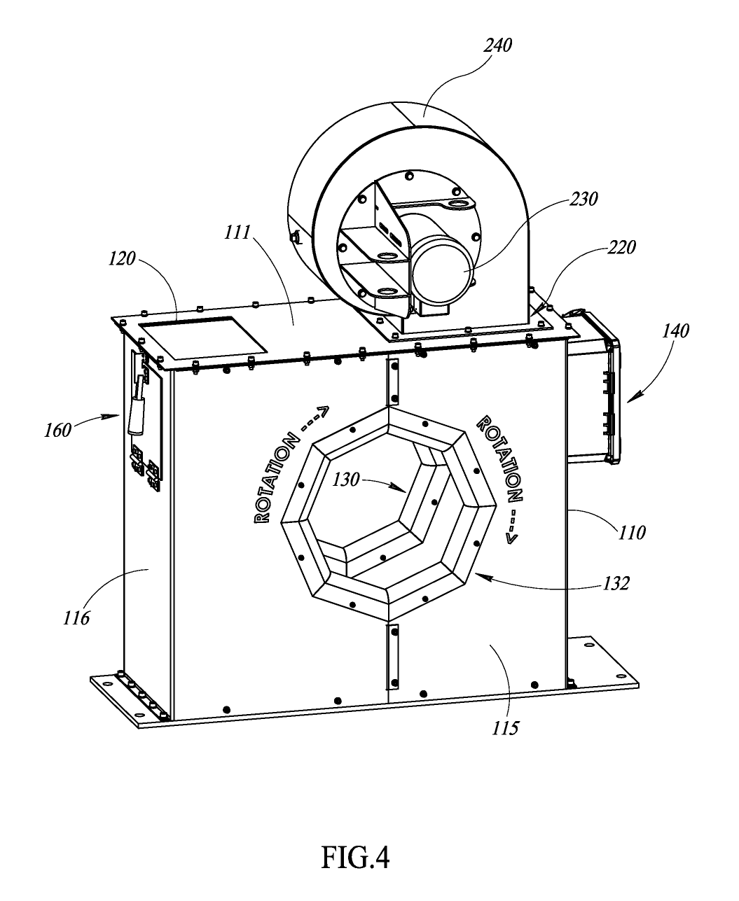

Furthermore, as discussed in more detail below, an air mover, such as the air mover 200 shown in FIGS. 3 and 4, may change the direction in which it moves air. For example, the air mover 200 may act in both a forced draft configuration and an induced draft configuration. A cooling air inlet during forced draft operation may be a cooling air outlet in inducted draft operation.

In addition to the cooling air inlet 122 and cooling air outlet 120, the shaft apertures 130 and 132 may also act as cooling air inlets and cooling air outlets. For example, the shaft apertures 130 and 132 may not seal with the motor and load shafts of the magnetic drive system. By not sealing the shaft apertures 130 and 132 with the corresponding motor and load shafts, the gap formed between the circumference of the apertures 130 and 132 and the corresponding shaft may also act as a cooling air inlet in the case of induced draft operation, and as a cooling air outlet in the case of forced draft operation.

FIG. 2A shows an embodiment of a magnetic drive system. The magnetic drive system 300 includes a magnetic rotor assembly 310 and a conductor rotor assembly 320. The magnetic rotor assembly 310 includes a magnetic rotor 311. The magnet rotor 311 can comprise a magnet disc (e.g., a non-ferrous magnet disc) backed by a backing disc (e.g., a ferrous backing disc). The magnet rotor 311 is mounted on the load shaft 20 of a load 21, and rotates in unison therewith. Each of the magnet discs of the magnet rotor 311 can include a plurality (e.g. a circular array) of pockets to receive therein a respective permanent magnet.

The conductor rotor assembly 320 is mounted on the motor shaft 10 of a motor 11, and rotates in unison therewith. The conductor rotor assembly 320 can include a pair of conductor rotors 321 mounted to a backing plate 350 that are spaced apart from each other by spacers 322. Each of the conductor rotors 321 includes conductor rings which generally comprise non-ferrous material, such as copper, aluminum, brass, or other non-ferrous metals. The conductor rings are spaced apart from the magnet rotor assembly 310 by an air gap. The air gap may be a fixed air gap or may be an adjustable air gap. By way of example, some magnetic drive systems 300 may include an actuator assembly. The actuator assembly is coupled to the magnetic rotor assembly 310 in a known manner. The actuator assembly is configured to controllably move the magnet rotor assembly 310 with respect to the conductor rotor assembly 320, such that the air gap of the magnetic drive system 300 is adjustable. Moreover, while in the embodiment illustrated in FIG. 2A, the conductor rotor assembly 320 is mounted on the motor shaft 10 and the magnetic rotor assembly 310 is mounted on the load shaft 20, alternatively, the conductor rotor assembly 320 may be mounted on the load shaft 20 and the magnetic rotor assembly 310 may be mounted on the motor shaft 10. In this manner, the conductor rotor assembly 320 may rotate in unison with the load shaft 20 and the magnet rotors assembly 310 may rotate in unison with the motor shaft 10.

The illustrated magnetic drive system 300 further includes heat sink elements 40 that are coupled to the outwardly facing sides of the conductor rotor backing plate 350. The heat sink elements 40 may be coupled to the backing plate 350 via fastening, welding, adhering, or other suitable means. The illustrated magnetic drive system 300 also includes heat sink elements 41 that are coupled to the inwardly facing sides of the conductor rotor 321. The heat sink elements 41 may be coupled to the conductor rotor 321 via fastening, welding, adhering, or other suitable means.

FIG. 2B shows the conductor rotor 321, separate from the rest of the conductor rotor assembly 320. The conductor rotor 321 includes a body 319 having a central aperture 318 and an outer perimeter 317. The outer perimeter 317 includes alternating extensions 327, which may be referred to a protrusion, and notches 328. The notches 328 and extension 327 cooperate to provide for additional heat transfer via additional surface area, and for mounting heat sinks 41, and for clearance for spacers 322.

The conductor rotor 321 also includes apertures 325 for mounting heat sinks 40 on the outward facing side of the conductor rotor assembly 320, for example on the outward facing side of the backing plate 350, and apertures 326 for mounting heat sinks 41 to the inward facing side of the conductor rotor assembly 320, for example on the inward facing side of the conductor rotor 321.

In some embodiments, such as shown in FIG. 2A, the magnetic drive system 300 may also include temperature monitoring devices such as thermocouples 340. The thermocouples 340 can measure the temperatures of various parts of the magnetic drive system 300. For example, in some embodiments, the thermocouples 340 measure the temperature of one or more heat sink elements 40 or the temperature of one or more locations of the conduction rotor assembly 320 or the magnetic rotor assembly 310. The thermocouples 340 may be coupled to a transceiver, such as the magnetic drive transceiver 342 that is coupled to the conductor rotor assembly 320. The magnetic drive transceiver 342 may transmit temperature information to the controller 140 via a second transceiver 148. In some embodiments, rather than using the transceiver 342 to transmit the temperature information, a slip ring may be used to connect the thermocouples 340 with the controller 140 or to otherwise transmit the temperature information to the controller.

Referring now to FIGS. 3 and 4, an air mover 200 is shown coupled to the top 111 of the lower housing 110. The air mover 200 includes an air mover housing 240 with an air mover inlet 210 and an air mover outlet 220. The air mover 200 also includes a motor, such as the motor 230 that rotates the veins, blades, impeller, fan, or other device that imparts force on the cooling air to cause the cooling air to move. In the embodiment shown in FIG. 3, the air mover 200 includes an impeller 215 that pulls cooling air in through the inlet 210, accelerates the cooling air, and forces the air out the air mover 200 outlet 220. The cooling air then enters the lower housing 110 through the inlet 122. The magnetic drive system, not shown, then transfers heat to the cooling air and the heated cooling air exits the lower housing 110 through the outlet 120. Some of the heated cooling air may exit the lower housing 110 through the apertures 130 and 132.

In some embodiments, the air mover 200 may be bidirectional, such that the air mover 200 may change the direction in which it moves air. For example, in the above description, forced draft operation is described. During induced draft operation, the air mover 200 pulls air in through the outlet 220 and accelerates and expels the air out the inlet 210. In addition, during induced draft operation, cooling air may enter the lower housing 110 through the inlet 120 and the apertures 130, 132.

In some embodiments, an air mover may not be bidirectional. In such an embodiment, changing from forced draft operation to induced draft operation may include reconfiguration of the air mover, such that the air inlet 210 is coupled to the inlet 122 of the lower housing 110.

In some embodiments, two air movers 200 may be used. For example, a first air mover may be configured to operate in a forced draft configuration, such that it pushes cooling air into the lower housing 110 through the inlet 122. A second air mover 200 may be coupled to the outlet 120 of the lower housing 110 and configured to operate in an induced draft configuration, pulling air out of the lower housing 110 through the outlet 120. In embodiments with two air movers, the air movers 200 may be operated one at a time or both at the same time.

The rotational direction of the magnetic drive may be depicted on the outside of the housing, as shown in FIGS. 3 and 4. In an induced draft configuration, cooling air enters the housing through the outlet 120 and exits through the inlet 122. The cooling air may flow through the lower housing 110 in a clockwise direction, from the perspective of FIG. 3, while the magnetic drive may rotate in a counterclockwise direction. The counterflow of the air and the magnetic drive may increase the convection heat transfer rate of energy from the magnetic drive to the cooling air as compared to cooling air flowing in the same direction as the magnetic drive because the relative velocity of the air to the magnetic drive in a counterflow configuration is greater than the relative velocity of the air to the magnetic drive when both are moving or rotating in the same direction.

A controller 140 may control the air mover 200. In some embodiments, the controller 140 receives temperature information from temperature measuring devices, such as thermocouples 340. The controller 140 may use this temperature information to turn the air mover 200 on and off. For example, the controller 140 may turn the air mover 200 on when the temperature information indicates a temperature rises above a certain activation threshold and then turn the air mover off when the temperature drops below a deactivation threshold. In some embodiments, the activation threshold may be greater than the deactivation threshold, such that there is a hysteresis between the activation and deactivation thresholds. In some embodiments, the activation and deactivation thresholds may be the same.

In some embodiments, in addition to or in place of activating and deactivating the air mover 200 based on temperature, the controller 140 may adjust the speed of the veins, blades, impeller, fan, or other device that imparts force on the cooling air based on the temperature information. For example, once the activation threshold has been met, the controller may increase the speed based on increasing temperatures or based the temperature rising above additional temperature thresholds, and reduce speed based on decreasing temperatures or temperatures dropping below certain temperature thresholds.

In some embodiments, for example, embodiments with more than one air mover 200, the controller may activate a first air mover 200 when the temperature information exceeds a first activation threshold, and activate an additional air mover when the temperature information exceeds a second, higher, activation threshold.

The lower housing 110 may also include one or more access panels 160 for accessing the interior of the housing without dissembling the lower housing 110 or the enclosure 100.

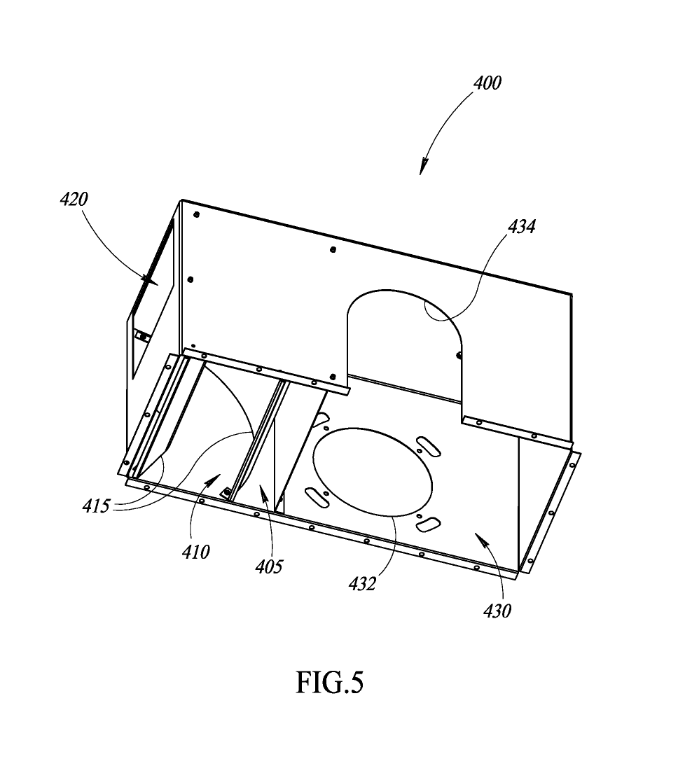

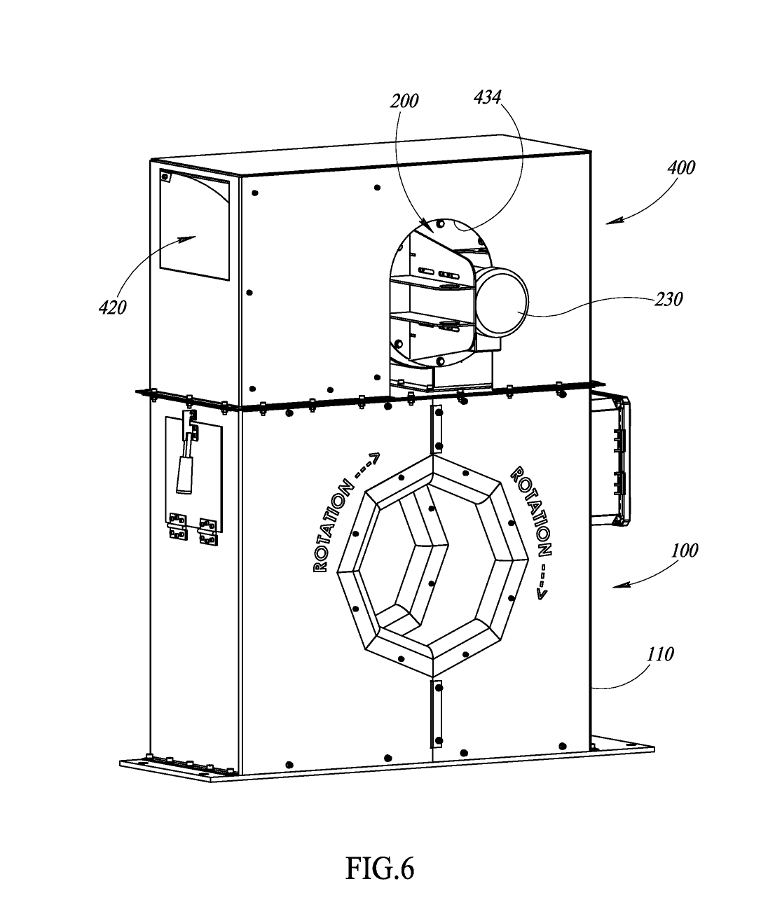

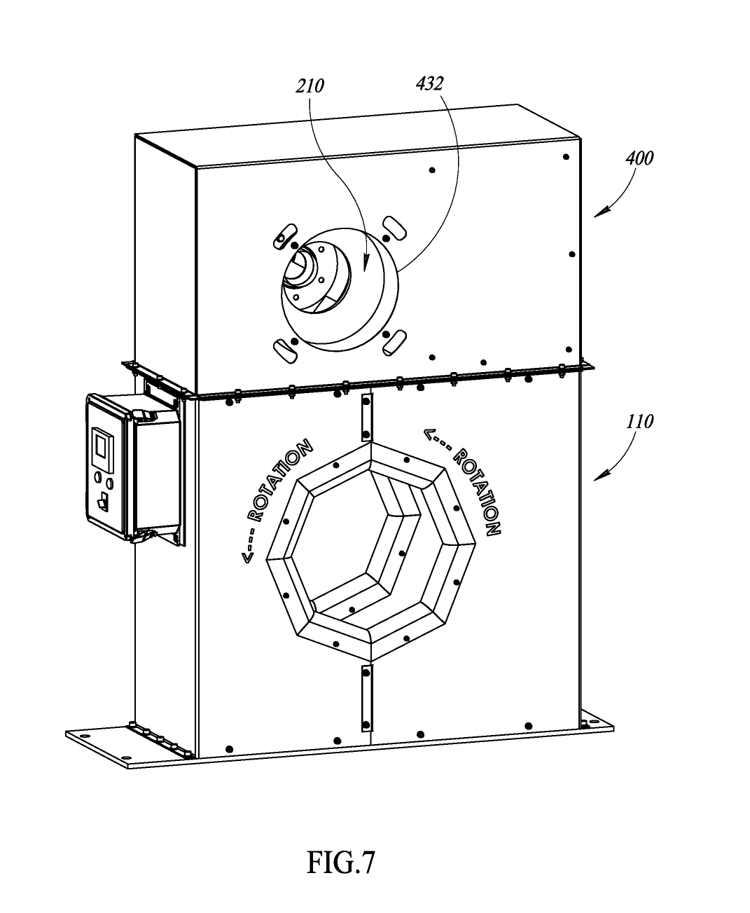

FIG. 5 shows an embodiment of an air mover housing 400 and FIGS. 6 and 7 show the air mover housing 400 coupled to the lower housing 110. The air mover housing 400 may include an air mover compartment 430 and an air outlet compartment 405. The air mover compartment 430 may be sized and shaped to substantially surround the air mover 200. The air mover compartment 430 includes an inlet aperture 432 that aligns with the inlet 210 of the air mover 200 when the air mover 200 and the air mover housing 400 are coupled or installed on the lower housing 110.

The air mover compartment 430 may also include a motor cutout 434. The motor cutout 434 may be sized and shaped to allow the motor 230 to protrude out of the air mover compartment 430 and the air mover housing 400.

The air outlet compartment 405 may guide and direct cooling air as it enters or exits the lower housing 110. The air outlet compartment 405 includes an inlet 410 and an outlet 420. In forced draft operation, the inlet 410 receives heated cooling air from the lower housing 110 and directs the heated cooling air out the outlet 420. During induced draft operation, the outlet compartment 405 receives ambient cooling air from the outlet 420 and directs the cooling air through the inlet 410 and into the lower housing 110.

The outlet compartment 405 may also include air guides or veins 415 that direct the air flowing through the outlet compartment. The guides or veins 415 may help to reduce the turbulence of the air as it flows through the outlet compartment 405. In some embodiments, the ends of the guides or veins 415 correspond with a perimeter of the outlet 420 or the inlet 410. In some embodiments, additional guides or veins 415 may be placed between the guides or veins 415 shown in FIG. 5 or elsewhere within the outlet compartment 405 to guide the flow of air through the outlet compartment.

The outlet 420 directs air out and away from the air mover inlet 210 and the inlet aperture 432 to aid in preventing heated cooling air from being pulled back into the air mover 200.

As shown in FIGS. 6 and 7, the air mover housing 400 may be coupled to the top of the lower housing 110. In some embodiments, the air mover housing 400 may include two or more separate parts. For example, the air mover compartment 430 and the outlet compartment 405 may be separate pieces that may each couple to the lower housing 110.

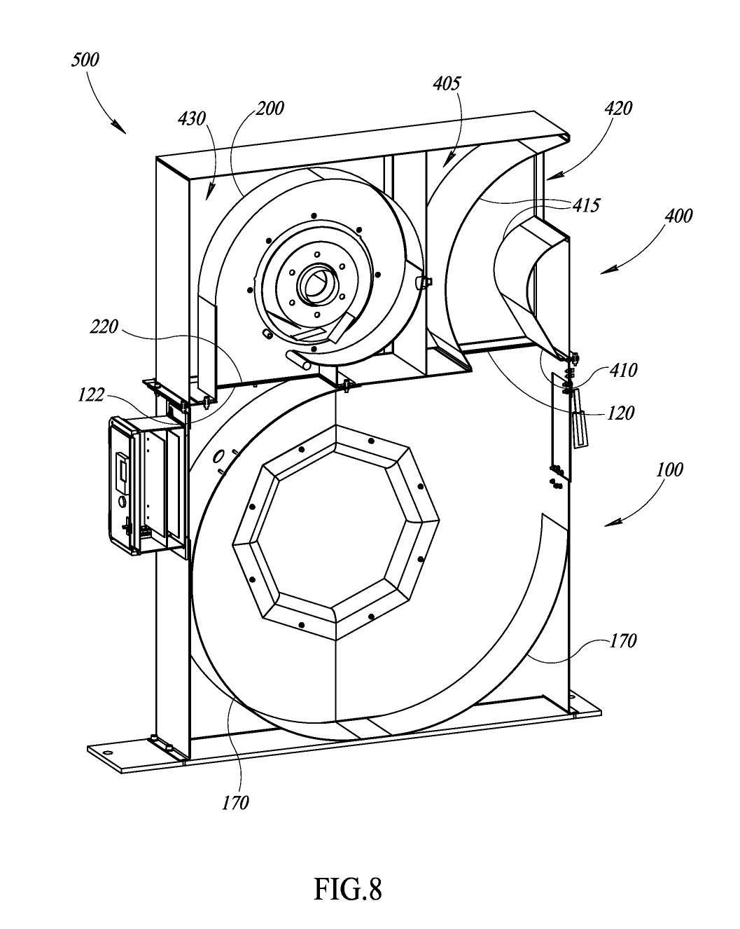

FIG. 8 shows a cross section of an assembled enclosure 500. The operation and flow of cooling air will be described in reference to forced draft operation. A person of skill in the air would understand the operation and flow in induced draft operation based on the description provided herein.

The air mover 200 pulls ambient cooling air in through the air mover inlet 210 and then accelerates the air and forces it out through the air mover outlet 220 and into the enclosure 100 and lower housing 110 through the air inlet 122. The air may be directed downward and may impinge on the guide or vein surface 170 that directed the air in a counter-clockwise direction. The air cools the magnetic drive, not shown, and then exits the enclosure 100 through the outlet 120 and may also exit through the apertures 130, 132. The outlet compartment 405 of the air mover housing 400 and the guides or veins 415 guide the heated cooling air out of the enclosure 500 and into the surrounding environment.

In general, the flow of air though the assembled enclosure 500 is reversed in induced draft operation with the air mover pulling ambient cooling air in through the apertures 130, 132 and forcing the air out through the air mover inlet 210.

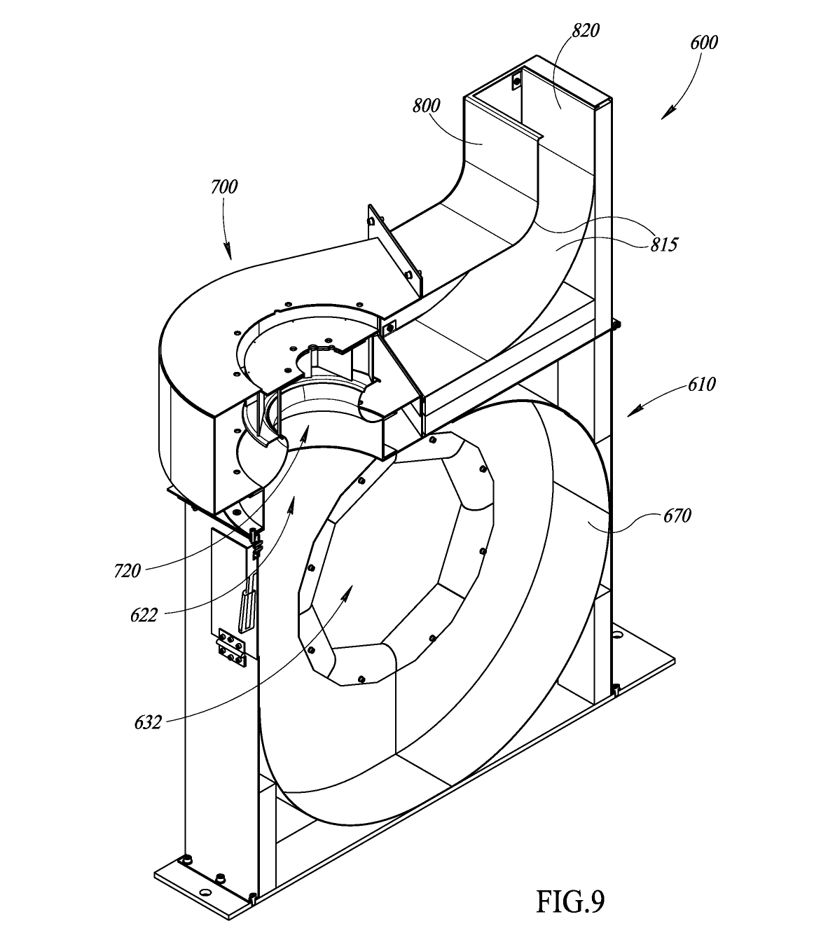

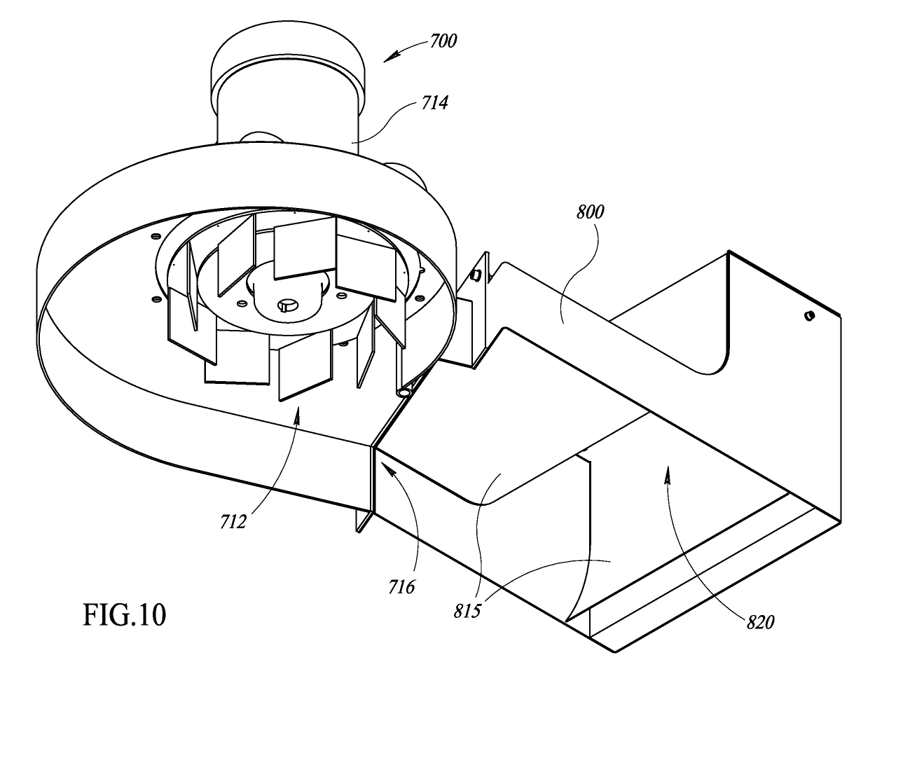

FIGS. 9 and 10 shows an embodiment of an assembled enclosure 600 in two cross-sectional views. FIG. 9 shows a view of a vertical elevation cross-section and FIG. 10 shows a view of a horizontal plan cross-sectional through the air mover 700 and outlet duct 800. The operation and flow of cooling air will be described in reference to induced draft operation. A person of skill in the air would understand the operation and flow in forced draft operation based on the description provided herein.

The air mover 700 pulls ambient cooling air in through the air mover inlet in through the apertures 632 and across the rotors of a magnetic drive system, not shown. The air is contained within the lower assembly 610 by the guides or veins 670. The air is then pulled through the air outlet 622 of the lower assembly 610 and through an air inlet 720 of an air mover 700. The motor 714 and connected impeller 712 then accelerates the air and forces it out through the air mover outlet 716 and into the enclosure outlet duct 800. The air may be directed though the outlet duct 800 by guide or vein surfaces 815 and out the outlet 820.

In general, the flow of air though the assembled enclosure 600 is reversed in forced draft operation with the air mover pulling ambient cooling air in through the outlet 820 and forcing the air into the lower assembly 610, over the rotors of the magnetic drive system, not shown, and out through the aperture 632.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system for cooling a magnetic drive comprising:
a housing including an interior and enclosing the magnetic drive, the housing including a cooling air inlet and a cooling air outlet, each in fluid communication with the interior of the housing, the magnetic drive including a conductor rotor assembly and a magnet rotor assembly; and
an air mover, the air mover including an air mover inlet and an air mover outlet, the air mover outlet in fluid communication with the cooling air inlet of the housing and the air mover inlet in fluid communication with ambient air external to the air mover.

2. The system of claim 1, further comprising:
a first aperture in the housing configured to receive a drive shaft therethrough.

3. The system of claim 1, further comprising:
a second aperture in the housing configured to receive a load shaft therethrough.

4. The system of claim 1, wherein the conductor rotor assembly and a magnet rotor assembly form a magnetic coupling.

5. The system of claim 1, wherein the air mover is configured to draw the ambient air external to the air mover in through the air mover inlet and push the ambient air into the interior of the housing.

6. The system of claim 1, further comprising:
a duct having an inlet and an outlet and coupling the interior of the housing in fluid communication with the ambient air external to the air mover, the duct outlet in fluid communication with the ambient air external to the air mover and the duct inlet coupled to the cooling air outlet and in fluid communication with the interior of the housing.

7. The system of claim 6, wherein:
the duct outlet is configured to direct air in a direction away from the air mover inlet.

8. The system of claim 1, further comprising:
a duct having an inlet and an outlet and coupling the air mover in fluid communication with the ambient air external to the air mover, the duct inlet in fluid communication with the ambient air external to the air mover and the duct outlet coupled to the cooling air inlet of the air mover and in fluid communication with the air mover.

9. The system of claim 8, wherein:
the duct outlet is configured to direct air in a direction away from the air mover inlet.

10. The system of claim 8, further comprising:
a first aperture in the housing configured to receive a drive shaft therethrough, the first aperture being the cooling air inlet and being coupled in fluid communication with the interior of the housing and the ambient air external to the air mover.

11. The system of claim 10, wherein the air mover is configured to draw the ambient air external to the air mover in through the first aperture and push the ambient air out though the duct.

12. A cooling apparatus for a magnetic drive or coupling comprising:
a lower housing enclosing the magnetic drive or coupling, the lower housing including a drive shaft aperture, a load shaft aperture, and a top surface including a cooling air inlet and a cooling air outlet;
an air mover housing coupled to the top surface of the lower housing, the air mover housing including an air mover compartment and an air outlet compartment, the air mover compartment enclosing an air mover and having an air inlet aperture, the air mover including a cooling air inlet and a cooling air outlet, the cooling air outlet of the air mover in fluid communication with the cooling air inlet of the lower housing, the air outlet compartment coupling an external environment in fluid communication with an interior of the lower housing, the air outlet compartment including guide veins to direct cooling air between the interior of the lower housing and the external environment.

13. The cooling apparatus of claim 12, wherein the air mover is configured to draw ambient air external to the air mover in through the air mover inlet the air inlet aperture of the air mover compartment and push the ambient air into the lower housing.

14. The cooling apparatus of claim 12, wherein the air mover is configured to draw ambient air external to the air mover into the lower housing through the cooling air inlet and push the ambient air out to the external environment through the air outlet compartment.

15. A method of cooling a magnetic drive or coupling comprising:
measuring a temperature of the magnetic drive or coupling;
comparing the measured temperature to a temperature threshold;
activating an air mover if the measured temperature is greater than the temperature threshold;
moving air from an external environment and into an enclosure that encloses the magnetic drive or coupling;
removing heat from the magnetic drive or coupling; and
exhausting the air back out to the external environment.

16. The method of claim 15, further comprising:
measuring the temperature of the magnetic drive or coupling a second time;
comparing the second measured temperature to a second temperature threshold;
deactivating the air mover if the second measured temperature is less than the second temperature threshold.

17. The method of claim 15, wherein moving air from an external environment and into an enclosure that encloses the magnetic drive or coupling includes:
pulling air into an inside of the enclosure though a first aperture in the enclosure that is configured to receive a drive shaft therethrough and is in fluid communication with the external environment and the inside of the enclosure using the air mover.

18. The method of claim 17, wherein exhausting the air back out to the external environment includes:
pushing the air though a duct that is in fluid communication with the external environment and the inside of the enclosure using the air mover.

19. The method of claim 15, wherein moving air from an external environment and into an enclosure that encloses the magnetic drive or coupling includes:
pulling the air though a duct that is in fluid communication with the external environment using the air mover.

20. The method of claim 19, wherein exhausting the air back out to the external environment includes:
pushing the air into an inside of the enclosure and then through a first aperture in the enclosure that is configured to receive a drive shaft therethrough and is in fluid communication with the external environment and the inside of the enclosure using the air mover.
